(19) United States
(12) Patent Application Publication
(10) Pub. No.: US 2025/0110603 A1
(43) Pub. Date: Apr. 3, 2025

(54) METHOD AND DEVICE FOR DISPLAYING DESKTOP

(71) Applicant: Lenovo (Beijing) Limited, Beijing (CN)

(72) Inventors: Jianfei HE, Beijing (CN); Xiuzhen BAI, Beijing (CN)

(21) Appl. No.: 18/896,451

(22) Filed: Sep. 25, 2024

(30) Foreign Application Priority Data
Sep. 28, 2023 (CN) 202311278952.5

(51) Int. Cl. G06F 3/04812; G06F 3/01; G06F 3/04817; G06F 3/0489; G06F 3/14

(52) U.S. Cl. CPC G06F 3/04812; G06F 3/013; G06F 3/017; G06F 3/04817; G06F 3/0489; G06F 3/1423

(57) ABSTRACT

Method and device for desktop displaying are provided. The method includes determining a target desktop from at least two display desktops; and determining all display windows on the target desktop, and all display windows being displayed on the target desktop in a first display state. The at least two display desktops are either different display desktops of a same screen or display desktops of different screens.

### CROSS-REFERENCE TO RELATED APPLICATION

This application claims priority of Chinese Patent Application No. 202311278952.5, filed on Sep. 28, 2023, the entire contents of which are hereby incorporated by reference.

### FIELD OF THE DISCLOSURE

The present disclosure generally relates to the field of electronic technology and, more particularly, relates to method and device for desktop displaying.

### BACKGROUND

When a laptop is connected to an external monitor for extended display, multiple windows are opened on multiple monitors. When the windows are open, minimizing each window can be troublesome. By clicking a “Show the Desktop” button at a far right of a toolbar or by pressing a shortcut key Win+D, windows that open on the screens of monitors may be minimized at a same time. However, if an external or main screen is being used for a screencast presentation, minimizing all windows by clicking the “Show the Desktop” button at a far right of a toolbar or by pressing the shortcut key Win+D may affect effectiveness of the screencast presentation.

### BRIEF SUMMARY OF THE DISCLOSURE

One aspect of the present disclosure provides a method for desktop displaying. The method includes determining a target desktop from at least two display desktops; and determining all display windows on the target desktop, the all display windows being displayed on the target desktop in a first display state, and the at least two display desktops being either different display desktops of a same screen or display desktops of different screens.

Another aspect of the present disclosure provides an electronic device. The electronic device includes one or more processors, and a memory containing a computer program that, when being executed, causes the one or more processors to perform determining a target desktop from at least two display desktops; and determining all display windows on the target desktop, the all display windows being displayed on the target desktop in a first display state, and the at least two display desktops being either different display desktops of a same screen or display desktops of different screens.

Another aspect of the present disclosure provides a non-transitory computer readable storage medium containing executable instructions that, when being executed, cause at least one processor to perform determining a target desktop from at least two display desktops; and determining all display windows on the target desktop, the all display windows being displayed on the target desktop in a first display state, and the at least two display desktops being either different display desktops of a same screen or display desktops of different screens.

Other aspects of the present disclosure can be understood by a person skilled in the art in light of the description, the claims, and the drawings of the present disclosure.

### BRIEF DESCRIPTION OF THE DRAWINGS

FIG. 1A illustrates a schematic diagram of an implementation process for a method for desktop displaying consistent with various embodiments of the present disclosure.

FIG. 1B illustrates a schematic display diagram of a screen consistent with various embodiments of the present disclosure.

FIG. 1C illustrates a schematic diagram of a display desktop with different screens consistent with various embodiments of the present disclosure.

FIG. 2 illustrates a flow chart of a method for determining a target desktop consistent with various embodiments of the present disclosure.

FIG. 3A illustrates a flow chart of a method for desktop displaying consistent with various embodiments of the present disclosure.

FIG. 3B illustrates a schematic diagram of operating desktop keys consistent with various embodiments of the present disclosure.

FIG. 3C illustrates a flow chart for determining a target screen consistent with various embodiments of the present disclosure.

FIG. 3D illustrates another flow chart for determining a target screen consistent with various embodiments of the present disclosure.

FIG. 4A illustrates a schematic diagram of displaying a plurality of screen logos on one screen simultaneously consistent with various embodiments of the present disclosure.

FIG. 4B illustrates another schematic display diagram of a screen consistent with various embodiments of the present disclosure.

FIG. 5 illustrates a compositional structural view of a display desktop consistent with various embodiments of the present disclosure.

FIG. 6 illustrates a hardware entity diagram of an electronic device consistent with various embodiments of the present disclosure.

### DETAILED DESCRIPTION

To make purposes, technical solutions and advantages of the embodiments of the present disclosure clearer, specific technical solutions of the embodiments in the present disclosure will be further described in detail below in conjunction with accompanying drawings in the embodiments of the present disclosure. The embodiments described below are used to illustrate the present disclosure but are not intended to limit the scope of the present disclosure.

In the following description, reference is made to “some embodiments” which describe a subset of all possible embodiments. It is understood that “some embodiments” may refer to a same subset or different subsets of all possible embodiments and may be combined with each other without conflict.

In the following description, terms “first\second\third” are only used to distinguish similar objects and do not indicate a specific order of objects. It is understandable that a specific order or sequence of “first\second\third” may be interchanged where applicable, so that the embodiments of the present disclosure described herein can be implemented in an order other than the embodiments illustrated or described herein.

Unless otherwise defined, all technical and scientific terms used herein have same meanings as commonly understood by a person skilled in the art. The terms used herein are intended only to describe the embodiments of the present disclosure and are not intended to limit the present disclosure.

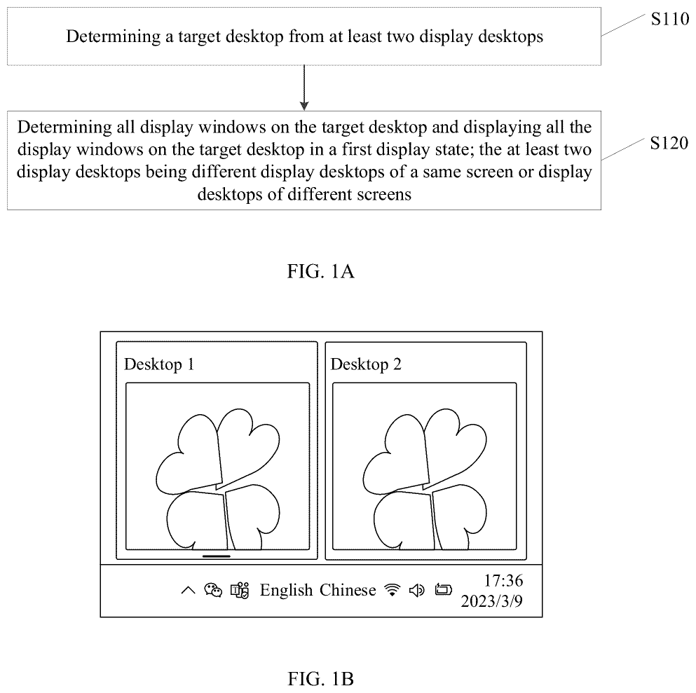

One embodiment provides a method for desktop displaying, as shown in FIG. 1A. The method may include the following steps.

S110: determining a target desktop from at least two display desktops.

The at least two display desktops can be either different display desktops of a same screen or display desktops of different screens.

In some embodiments, the at least two display desktops are either different display desktops of a same screen, that is, at least two display desktops are displayed on one screen. FIG. 1B illustrates a schematic display diagram of a screen consistent with various embodiments of the present disclosure. As illustrated in FIG. 1B, two desktops (desktop 1 and desktop 2) are displayed on the screen. During implementation, either desktop 1 or desktop 2 can be selected as a target desktop.

In some embodiments, the at least two display desktops are display desktops on different screens, that is, different desktops displayed on different screens. FIG. 1C illustrates a schematic diagram of a display desktop with different screens consistent with various embodiments of the present disclosure. As illustrated in FIG. 1C, the schematic diagram includes screen 11 and screen 12. A display content of screen 11 and screen 12 can be different, and any screen can also display a plurality of desktops. For example, screen 12 displays two desktops. During implementation, the target desktop can be determined on screen 11 and screen 12.

S120: determining all display windows on the target desktop and displaying all the display windows on the target desktop in a first display state.

During implementation, all the display windows on the target desktop can be determined. As illustrated in FIG. 1B, all display windows on either desktop 1 or desktop 2 can be determined. As illustrated in FIG. 1C, all display windows on desktop 1 on screen 11 can be determined, and all display windows on desktop 1 or desktop 2 on screen 12 can also be determined.

All display windows are displayed on the target desktop in the first display state. All the display windows displayed on the target desktop can be minimized or be tiled in a same display state. The first display state is not limited herein.

In one embodiment, the target desktop is determined from at least two display desktops, all display windows on the target desktop are determined, and all the display windows are displayed on the target desktop in the first display state. Therefore, all the display windows on the target desktop are in the first display state without affecting displays of other display desktops.

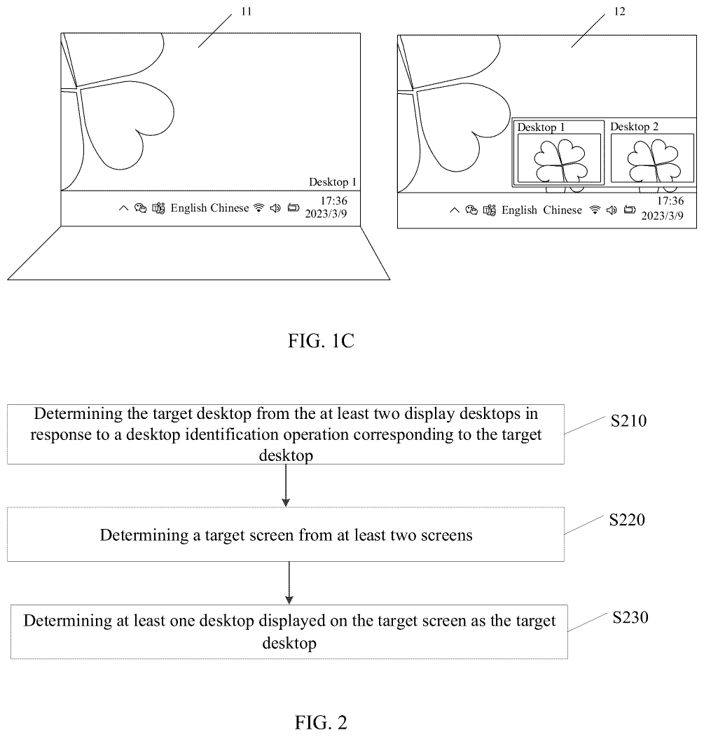

In some embodiments, as illustrated in FIG. 2, S110 can be implemented by at least one of the following steps.

S210: determining the target desktop from the at least two display desktops in response to a desktop identification operation corresponding to the target desktop.

A desktop logo can be a desktop thumbnail, a desktop image, or a desktop text logo. During implementation, a user can select the desktop logo or trigger an operation to determine the target desktop from at least two display desktops. For example, as illustrated in FIG. 1B, the user can click desktop 1 to identify desktop 1 as the target desktop. As illustrated in FIG. 1C, the user can click the desktop thumbnail desktop 2 on screen 12 to determine desktop 2 as the target desktop.

S220: determining a target screen from at least two screens.

During implementation, if there are at least two screens, the target screen can be determined. For example, as illustrated in FIG. 1C, there are screen 11 and screen 12, and either screen 11 or screen 12 can be determined as the target screen.

S230: determining at least one desktop displayed on the target screen as the target desktop.

In some embodiments, a current desktop displayed on the target screen may be determined as the target desktop. As illustrated in FIG. 1C, a current desktop displayed on screen 11 can be determined as the target desktop. Therefore, only all windows currently displaying on the desktop cm be minimized.

In some embodiments, a non-current desktop displayed on the target screen may be determined as the target desktop. For example, a non-current desktop may be a currently minimized desktop. Therefore, all windows that are not on a currently display desktop can be minimized.

In some embodiments, all desktops displayed on the target screen may be determined to be target desktops. As illustrated in FIG. 1C, all desktops displayed on screen 12 can be determined as target desktops. Therefore, windows on all the desktops can be minimized and displayed on the entire target screen. For example, in a sleep mode, an electronic device can minimize all desktops on the target screen.

In one embodiment, the target desktop may be determined from the at least two display desktops in response to a desktop identification operation corresponding to the target desktop. Therefore, the desktop identification operation can be implemented to determine the target desktop.

A target screen may be determined from at least two screens. At least one desktop displayed on the target screen may be determined as the target desktop. Therefore, the target desktop displayed on one target screen can be determined from at least two screens.

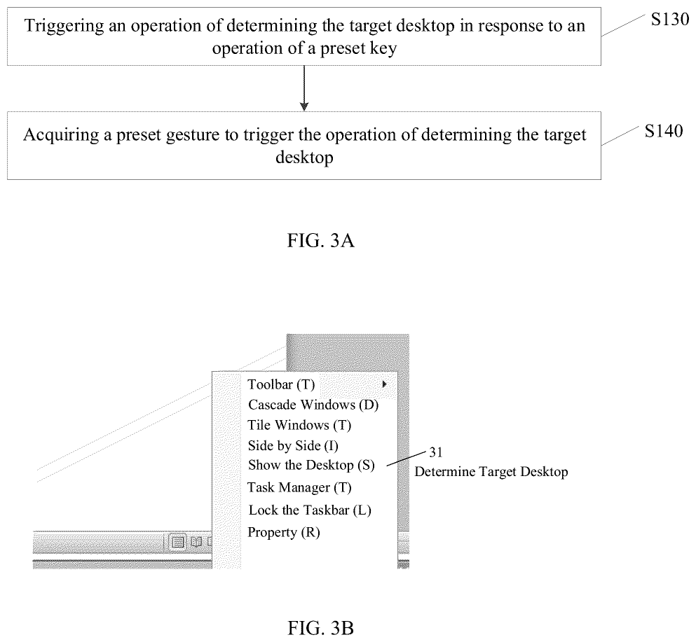

In some embodiments, as illustrated in FIG. 3A, the method of desktop displaying further includes at least one of the following steps.

S130: triggering an operation of determining the target desktop in response to an operation of a preset key.

The preset key can be preset individually according to an actual situation, or the preset key can be integrated into other keys. A shortcut key combination can be arranged to trigger the operation of determining the target desktop.

For example, a taskbar button can be triggered to display a desktop, specifically by using the “Show the Desktop” button on the taskbar. The taskbar can be at a bottom of a screen, where a system time and open window icons are displayed. FIG. 3B illustrates a schematic diagram of operating desktop keys consistent with various embodiments of the present disclosure. As illustrated in FIG. 3B, right clicking a mouse on the taskbar can display button 31 for selecting the target desktop among buttons for operating a desktop window. A user can click button 31 to trigger the operation of determining the target desktop.

S140: acquiring a preset gesture to trigger the operation of determining the target desktop.

During implementation, a user can arrange the preset gesture according to usage habits of the user. When a gesture sensor detects the preset gesture, the operation of determining the target desktop is triggered. The preset gesture can be a gesture performed in space or a gesture triggered on a touch screen. For example, the user can set a check gesture (such as a “V”) as a default gesture. When the user makes a check gesture on a screen or space, the operation of determining the target desktop can be triggered.

In one embodiment, in response to either an operation of the preset key or an acquisition of the preset gesture, the operation of determining the target desktop is triggered. Therefore, the operation of determining the target desktop can be triggered based on the operation of the preset keys or the preset gesture.

In some embodiments, as illustrated in FIG. 3C, S220 includes at least one of the following steps.

S221: determining the target screen based on position information of a cursor pointer.

In some embodiments, a screen coordinate range of each screen may be acquired. Based on the screen coordinate range of each screen and the position information of the cursor pointer, a screen where the cursor pointer is located is determined as the target screen.

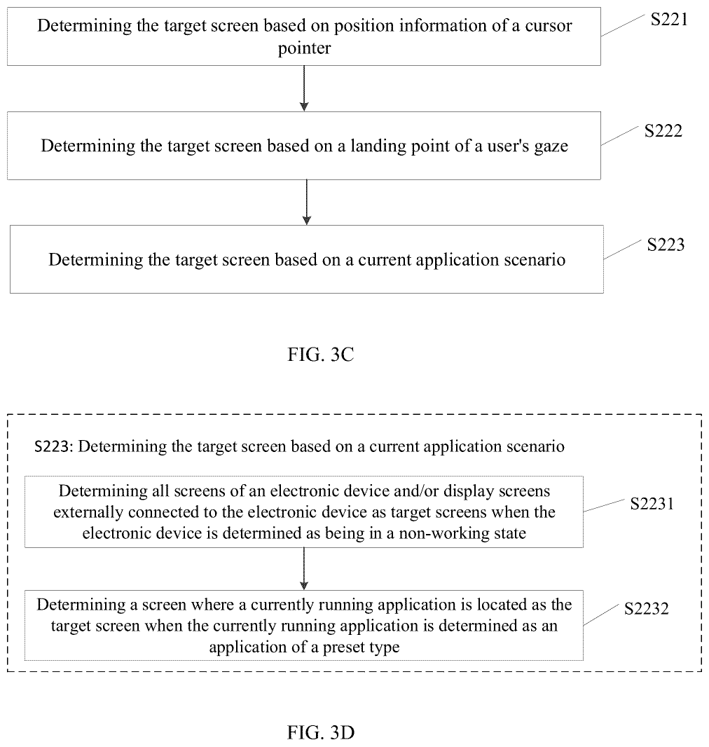

In some embodiments, it may be determined that the cursor pointer hovers over a display screen control based on first position information. A display of a plurality of screen selection boxes can be triggered based on the display screen control. The plurality of screen selection boxes corresponds one-to-one with a plurality of screens included in an extended mode. A target screen selection box is determined among the plurality of screen selection boxes based on second position information to determine the target screen. The target screen selection box corresponds to the target screen. FIG. 4A illustrates a schematic diagram of displaying a plurality of screen logos on one screen simultaneously consistent with various embodiments of the present disclosure. For example, as illustrated in FIG. 4A, thumbnails of screen 1 and screen 2 are displayed simultaneously on screen 1. During implementation, thumbnails of screen 1 and screen 2 may be displayed based on the first position information. Either screen 1 or screen 2 may be determined as the target screen based on the second position information. Clicking on screen 1 may determine screen 1 as the target screen.

S222: determining the target screen based on a landing point of a user's gaze.

During implementation, an attention sensor can be used to acquire the landing point of the user's gaze. A screen corresponding to the landing point of the user's gaze is determined as the target screen. For example, a camera device of an electronic device can be used to acquire the user's gaze.

S223: determining the target screen based on a current application scenario.

The current application scenario includes a work scenario, a non-work scenario, or a window where a user determines that a specific program is running.

In some embodiments, as illustrated n in FIG. 3D, S223 can be implemented by the following steps.

S2231: determining all screens of an electronic device and/or display screens externally connected to the electronic device as target screens when the electronic device is determined as being in a non-working state.

During implementation, the electronic device being in the non-working state may be the electronic device being in a hibernation or sleep state. All screens of the electronic device can be determined as target screens, or the display screen external to the electronic device can be determined as target screens. All the screens of the electronic device and the display screens external to the electronic device can also be determined as target screens. A user can preset strategies for determining the target screens in the non-working state according to actual strategies.

S2232: determining a screen where a currently running application is located as the target screen when the currently running application is determined as an application of a preset type.

The preset type of application may be an application involving user's personal privacy information such as a confidential document being edited, a chat application, or the like. When a user leaves a screen, a screen where the currently running application is located can be determined as the target screen to minimize a window on the target screen and securely protect the user's personal privacy information.

In one embodiment, the target screen can be determined based on the position information of the cursor pointer or the landing point of the user's gaze. Alternatively, the target screen may be determined based on the current application scenario. Therefore, the target desktop on which the user needs to display all windows in the first display state can be effectively determined.

In some embodiments, S110 can be implemented by the following steps.

S114: displaying window logos of all desktops.

In some embodiments, window logos of all desktops on a screen of the electronic device are displayed on the screen.

In some embodiments, the window logos of all desktops on the screen of the electronic device and logos of desktops on an extended screen of the screen can be displayed on the screen simultaneously.

S115: determining at least one target desktop in response to at least one of window identification selection instruction for the desktops.

In some embodiments, one target screen may be determined in response to a user's window identification selection instruction, and one target desktop on the target screen may be determined.

In some embodiments, in response to a user's window identification selection instruction, at least two target desktops on a same screen may be determined, or at least two target desktops on different screens may be determined.

Accordingly, S120 can be implemented through the following process: displaying all display windows on the at least one target desktop in the first display state.

During implementation, all display windows on the determined target desktop(s) may be displayed on the target desktop in the first display state. For example, all display windows on the target desktop can be minimized.

In one embodiment, window logos of all desktops are displayed. In response to at least one window identification selection instruction for the desktops, at least one target desktop is determined. All display windows on the at least one target desktop are displayed on the target desktop in the first display state. Therefore, one target desktop on one screen can be displayed in the first display state, and a plurality of target desktops on a plurality of screens can be displayed in the first display state.

In some embodiments, S110 can be implemented through the following process: displaying all display desktop logos from a second screen on a first screen, determining the target desktop on the second screen in response to an operation performed on the first screen for displaying desktop logos on the second screen, and setting all windows on display desktops on the second screen to the first display state.

The first screen may be a screen of the electronic device, and the second screen may be an extended screen of the first screen, in which all desktop logos on the second screen are displayed. FIG. 4B illustrates another schematic display diagram of a screen consistent with various embodiments of the present disclosure. As illustrated in FIG. 4B, desktop 1 and desktop 2 of screen 2 are displayed on screen 1.

During implementation, a user can operate on the first screen to display the desktop logos on the second screen and determine the target desktop of the second screen. For example, as illustrated in FIG. 4B, the user can identify an operation on desktop 1 or desktop 2 from the second screen displayed on the first screen, determine either desktop 1 or desktop 2 as the target desktop, and minimize all windows on the target desktop.

In one embodiment, all desktop logos from the second screen are displayed on the first screen, the target desktop on the second screen is determined in response to an operation performed on the first screen for displaying desktop logos on the second screen, and all windows on the display desktop on the second screen are set to the first display state. Therefore, a desktop on the second screen can be controlled on the first screen, and all windows on the target desktop of the second screen can be set to the first display state.

In some embodiments, the method of desktop displaying further includes the following steps.

S170: displaying display windows in a second display state on the target desktop in response to a triggering operation on all display windows on the target desktop, the second display state being different from the first display state.

During implementation, the user can trigger the operation on all the display windows on the target desktop to display all the display windows on the target desktop in the second display state that is different from the first display state. For example, when an electronic device switches from a non-working state to a working state, or when a user transitions from leaving to approaching the electronic device, the display windows can be displayed on the target desktop in the second display state. For example, minimized windows may be restored and displayed so that the user can view the restored windows normally.

In one embodiment, in response to the triggering an operation on all display windows on the target desktop, the display windows are displayed in the second display state on the target desktop. The second display state is different from the first display state. Therefore, when a user needs to display the display windows in the second display state, an operation can be triggered to meet user's usage needs.

In some embodiments, S110 can be implemented through the following process: determining the target desktop when an external screen of the electronic device is in a copy mode. When the external screen of the electronic device is in the copy mode, at least one target desktop can be determined.

Accordingly, S120 can be implemented through the following process: determining target desktops on all screens to be displayed in the first display state.

During implementation, since display and operation of all screens are same in the copy mode, the target desktops are displayed on all screens in the first display state. For example, when an external screen of the electronic device is in the copy mode, windows on desktops can be minimized simultaneously across all screens.

In one embodiment, when the external screen of the electronic device is set to the copy mode, target desktops are determined, and it is confirmed that the target desktops are displayed in the first display state across all screens. Therefore, it can be realized that when the external screen of the electronic device is in the copy mode, the desktops on all screens can be displayed in the first display state simultaneously.

One embodiment provides the following two application scenarios.

In scenario one, it is determined that there is an external monitor in an extended mode, and a function to display a desktop is enabled. When a mouse hovers over the “Show the Desktop” button, a selection box for a plurality of screens can pop up, all windows on a screen are minimized by clicking the screen, and all the windows are restored by clicking the screen again.

In scenario two, when a plurality of desktops is displayed on one screen, if the plurality of desktops is detected, a function to display the plurality of desktops is enabled. When a mouse hovers over the “Show the Desktop” button, a selection box for a plurality of desktops can pop up, all windows on a desktop are minimized by clicking a screen, and all the windows are restored by clicking the screen again.

One embodiment provides a method for minimizing a screen based on a shortcut key, such as Win+D, which includes the following steps.

S410: monitoring position information of a mouse on a screen, that is, x and y coordinates.

S420: acquiring a coordinate range of the screen, that is, rect (x, y, width, height).

S430: determining a target screen for a corresponding mouse operation based on the rect of each screen and the position information of the mouse when the shortcut key Win+D triggers a screen display.

S440: minimizing all windows on the target screen.

In the embodiment, a method for minimizing the screen based on the shortcut key is provided. The position information of the mouse can be used to determine a minimization of all windows on the target screen.

Based on the above method embodiments, a device for desktop displaying is provided in one embodiment. The device includes various modules, and each module includes sub-modules, which can be implemented by a processor in an electronic device or by specific logic circuits. During implementation, the processor can be a central processing unit (CPU), a microprocessor unit (MPU), a digital signal processor (DSP) or a field programmable gate array (FPGA), or the like.

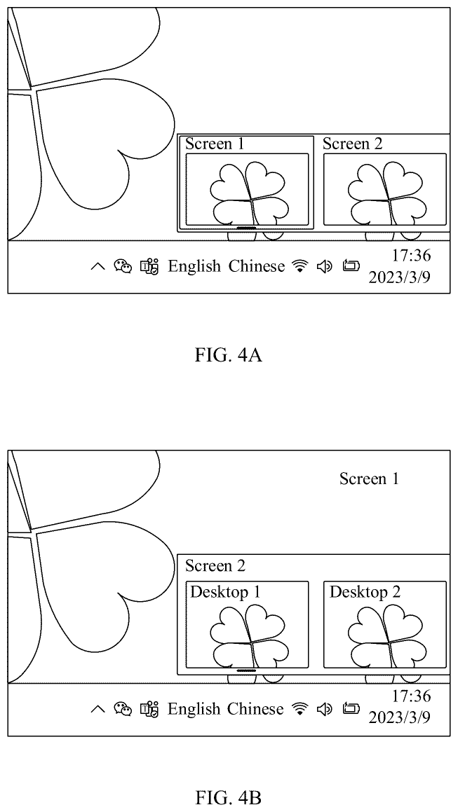

FIG. 5 illustrates a compositional structural view of a display desktop consistent with various embodiments of the present disclosure. As illustrated in FIG. 5, a device 500 includes: a first determination module 510 configured for determining a target desktop from at least two display desktops; and a second determination module 520 configured for determining all display windows on the target desktop, and all display windows being displayed on the target desktop in a first display state. The at least two desktops are different display desktops on a same screen, or display desktops on different screens.

In some embodiments, the first determination module 510 is further configured for determining the target desktop from the at least two display desktops in response to a desktop identification operation corresponding to the target desktop. Alternatively, the first determination module 510 includes a first determination sub-module and a second determination sub-module. The first determination sub-module is configured for determining a target screen from at least two screens. The second determination sub-module is configured for determining at least one desktop displayed on the target screen as the target desktop.

In some embodiments, the device further includes a first trigger module, or a second trigger module. The first trigger module is configured for triggering an operation of determining the target desktop in response to an operation of a preset button. The second trigger module is configured for acquiring a preset gesture and trigger an operation of determining the target desktop.

In some embodiments, the first determination sub-module is configured for determining the target screen based on position information of a cursor pointer; or is configured for determining the target screen based on a landing point of the user's line of sight; or is configured for determining the target screen based on a current application scenario.

In some embodiments, the first determination module 510 includes a display sub-module and a third determination sub-module. The display sub-module is configured for displaying window logos of all desktops. The third determination sub-module is configured for determining at least one target desktop in response to at least one window identification selection instruction for the desktops.

In some embodiments, the first determining module is configured for displaying all display desktop logos from a second screen on a first screen in response to an operation performed on the first screen for the display desktop logos on the second screen and determining the target desktop on the second screen. All windows on display desktops on the second screen are set to the first display state.

In some embodiments, the device further includes a display module configured for displaying display windows in a second display state on the target desktop in response to a triggering operation on all display windows on the target desktop. The second display state is different from the first display state.

In some embodiments, the first determination module 510 is configured for determining the target desktop when an external screen of the electronic device is in a copy mode. Accordingly, the second determination module 520 is configured for determining target desktops on all screens to be displayed in the first display state.

The description of the above device embodiment is like the description of the above method embodiments and has similar beneficial effects as the method embodiments. Technical details not disclosed in the device embodiment can be understood by referring to the description of the method embodiments.

It should be noted that, in one embodiment, if the method described in the method embodiments is implemented as a software function module and sold or used as an independent product, the above method can also be stored in a computer-readable storage medium. Therefore, technical solutions of the above embodiments are essentially or contributes to a relevant technology and can be embodied as a software product. The software product, stored on a storage medium, includes instructions that enable an electronic device, such as a mobile phone, a tablet computer, a notebook computer, a desktop computer, or the like to execute all or part of the methods described in various embodiments of the present disclosure. The storage medium includes a U disk, a mobile hard disk, a read only memory (ROM), a magnetic disk, an optical disk, or any other medium capable of storing program instructions. The embodiment is not limited to any specific combination of hardware and software.

Accordingly, one embodiment provides a storage medium where a computer program is stored. When executed by a processor, the computer program implements steps in the method for desktop displaying as described in the above embodiments.

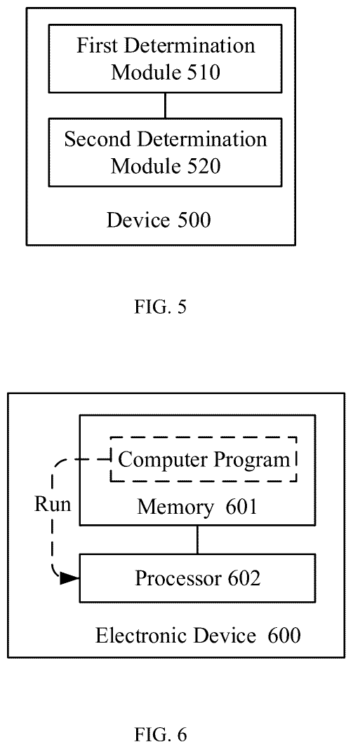

Accordingly, an electronic device is provided in one embodiment. FIG. 6 illustrates a hardware entity diagram of an electronic device consistent with various embodiments of the present disclosure. As illustrated in FIG. 6, the hardware entity of an electronic device 600 includes: a memory 601 and at least one processor 602. The memory 601 stores a computer program that can be run on the at least one processor 602. When the at least one processor 602 executes the program, the at least one processor 602 performs steps of the method for desktop displaying provided in the above embodiments.

The memory 601 is configured for storing instructions and applications executable by the at least one processor 602. The memory 601 can also cache data to be processed or processed by the at least one processor 602 and each module in the electronic device 600, including image data, audio data, voice communication data and video communication data. The memory 601 can be implemented through flash memory (FLASH) or random access memory (RAM).

It should be noted that, the above description of the storage medium and the electronic device embodiments is similar to the description of the above method embodiments and has similar beneficial effects as the method embodiments. Technical details not disclosed in the storage medium and device embodiments of the present disclosure can be understood by referring to the description of the method embodiments of the present disclosure.

It will be understood that references to “one embodiment” or “an embodiment” throughout the present specification means that particular features, structures, or characteristics associated with the embodiment is included in at least one embodiment of the present application. Therefore, appearances of “in one embodiment” or “in an embodiment” in various places throughout the present specification are not necessarily referring to a same embodiment. Furthermore, the particular features, structures or characteristics may be combined in any suitable manner in one or more embodiments. In the various embodiments of the present disclosure, sequence numbers of the processes described above does not imply an execution order. The execution order of each process should be determined by functions and internal logic thereof and should not constitute any limitation on the implementation process of the embodiment of the present disclosure. Serial numbers of the embodiments of the present disclosure are only for description and do not represent advantages and disadvantages of the embodiments.

It should be noted that in the present specification, terms “comprises,” “includes,” or any other variation thereof are intended to cover a non-exclusive inclusion such that a process, method, article, or apparatus containing a list of elements includes not only those explicitly mentioned, but also other elements not expressly listed or inherent to the process, method, article, or apparatus. Without further limitation, an element defined by the statement “includes a . . . ” does not exclude the presence of additional identical elements in a process, method, article, or apparatus that includes the stated element.

In several embodiments provided in the present disclosure, the disclosed device and method for desktop displaying can be implemented in other ways. The device embodiment described above is only illustrative. For example, a division of units is only a logical function division. In actual implementation, other division methods may be used, such as combining a plurality of units or components, or integrating the plurality of units or components into another system or omitting or not implementing specific features. In addition, coupling, direct coupling, or communication connection between components shown or discussed may be through some interfaces, and the indirect coupling or communication connection of the devices or units may be electrical, mechanical, or other forms.

The units described above as separate components may or may not be physically separated. Components shown as units may or may not be physical units and may be in one place or distributed to a plurality of network units. Part or all of the units can be selected according to actual needs to implement a solution in one embodiment.

Each functional unit in each embodiment of the present disclosure can all be integrated into one processing unit, or each unit can be treated as a separate unit, or two or more units can be integrated into one unit. The integrated units can be implemented either as hardware alone or as a combination of hardware and software functional units.

A person skilled in the art can understand that all or part of steps to implement the above method embodiments can be completed using hardware associated with program instructions. A program can be stored in a computer-readable storage medium. When the program is executed, steps including the above method embodiments are executed. The storage medium includes a mobile storage device, a read only memory (ROM), a magnetic disk, an optical disk or any other medium that can store program instructions.

If the integrated units of the present disclosure are implemented as software function modules and sold or used as independent products, the integrated units can also be stored in a computer-readable storage medium. Therefore, the software product, stored on a storage medium, includes instructions that enable an electronic device, such as a mobile phones, a tablet computer, a notebook computer, a desktop computer, or the like to execute all or part of the methods described in various embodiments of the present disclosure. The storage medium includes a U disk, a mobile hard disk, a read only memory (ROM), a magnetic disk, an optical disk, or any other medium capable of storing program instructions.

Methods disclosed in several method embodiments of the present disclosure can be combined arbitrarily to obtain new method embodiments without conflict.

Features disclosed in several product embodiments of the present disclosure can be combined arbitrarily without conflict to obtain new product embodiments.

Features disclosed in several method or device embodiments of the present disclosure can be combined arbitrarily without conflict to obtain new method embodiments or device embodiments.

As disclosed, the method and device for desktop displaying provided by the present disclosure at least realize the following beneficial effects.

In the method for desktop displaying, a target desktop is determined from at least two display desktops, all display windows on the target desktop are determined, and all display windows are displayed on the target desktop in a first display state. Therefore, all display windows on the target desktop can be set to the first display state without affecting displays of other display desktops.

The above are only embodiments of the present disclosure, but the protection scope of the present disclosure is not limited thereto. A person skilled in the art can also make changes or substitutions within the technical scope disclosed in the present disclosure. The changes or substitutions should be covered by the protection scope of the present disclosure. Therefore, the protection scope of the present disclosure should be subject to the protection scope of the claims.

What is claimed is:

1. A method for desktop displaying, comprising:
determining a target desktop from at least two display desktops; and
determining all display windows on the target desktop, the all display windows being displayed on the target desktop in a first display state, and the at least two display desktops being either different display desktops of a same screen or display desktops of different screens.

2. The method according to claim 1, wherein determining the target desktop from the at least two display desktops includes:
determining the target desktop from the at least two display desktops in response to a desktop identification operation corresponding to the target desktop; or
determining a target screen from at least two screens; and determining at least one desktop displayed on the target screen as the target desktop.

3. The method according to claim 1, further comprising:
triggering an operation of determining the target desktop in response to an operation of a preset key; or
acquiring a preset gesture to trigger an operation of determining the target desktop.

4. The method according to claim 2, wherein determining the target desktop from the at least two display desktops includes:
determining the target screen based on position information of a cursor pointer; or
determining the target screen based on a landing point of a user's gaze; or
determining the target screen based on a current application scenario.

5. The method according to claim 4, wherein determining the target screen based on the current application scenario includes:
determining all screens of an electronic device and/or display screens external to the electronic device are as target screens when the electronic device is determined as being in a non-working state; and
determining a screen where a currently running application is located as the target screen when the currently running application is determined as an application of a preset type.

6. The method according to claim 1, wherein
determining the target desktop from the at least two display desktops includes:
displaying window logos of all desktops;
determining at least one target desktop in response to at least one window identification selection instruction for the desktops; and
determining the all display windows on the target desktop, the all display windows being displayed on the target desktop in the first display state, includes:
displaying all display windows on the at least one target desktop in the first display state on the target desktop.

7. The method according to claim 1, wherein determining the target desktop from the at least two display desktops includes:
displaying all display desktop logos from a second screen on a first screen, determining the target desktop on the second screen in response to an operation performed on the first screen for displaying desktop logos on the second screen, and setting all windows on display desktops on the second screen to the first display state.

8. The method according to claim 1, further comprising:
displaying display windows in a second display state on the target desktop in response to a triggering operation on all display windows on the target desktop, the second display state being different from the first display state.

9. The method according to claim 1, wherein
determining the target desktop from the at least two display desktops includes:
determining the target desktop when an external screen of an electronic device is determined to be in a copy mode; and
determining the all display windows on the target desktop, the all display windows being displayed on the target desktop in the first display state, includes:
determining target desktops on all screens to be displayed in the first display state.

10. An electronic device, comprising:
one or more processors, and
a memory containing a computer program that, when being executed, causes the one or more processors to perform:
determining a target desktop from at least two display desktops; and
determining all display windows on the target desktop, the all display windows being displayed on the target desktop in a first display state and the at least two display desktops being either different display desktops of a same screen or display desktops of different screens.

11. The device according to claim 10, wherein the one or more processors are further configured to perform:
determining the target desktop from the at least two display desktops in response to a desktop identification operation corresponding to the target desktop; or
determining a target screen from at least two screens; and determining at least one desktop displayed on the target screen as the target desktop.

12. The device according to claim 10, wherein the one or more processors are further configured to perform:
triggering an operation of determining the target desktop in response to an operation of a preset key; or
acquiring a preset gesture to trigger an operation of determining the target desktop.

13. The device according to claim 11, wherein the one or more processors are further configured to perform:
determining the target screen based on position information of a cursor pointer; or
determining the target screen based on a landing point of a user's gaze; or
determining the target screen based on a current application scenario.

14. The device according to claim 13, wherein the one or more processors are further configured to perform:
determining all screens of an electronic device and/or display screens external to the electronic device are as target screens when the electronic device is determined as being in a non-working state; and
determining a screen where a currently running application is located as the target screen when the currently running application is determined as an application of a preset type.

15. The device according to claim 10, wherein the one or more processors are further configured to perform:
displaying window logos of all desktops;
determining at least one target desktop in response to at least one window identification selection instruction for the desktops; and
displaying all display windows on the at least one target desktop in the first display state on the target desktop.

16. The device according to claim 10, wherein the one or more processors are further configured to perform:
displaying all display desktop logos from a second screen on a first screen, determining the target desktop on the second screen in response to an operation performed on the first screen for displaying desktop logos on the second screen, and setting all windows on display desktops on the second screen to the first display state.

17. The device according to claim 10, wherein the one or more processors are further configured to perform:
displaying display windows in a second display state on the target desktop in response to a triggering operation on all display windows on the target desktop, the second display state being different from the first display state.

18. A non-transitory computer readable storage medium containing executable instructions that, when being executed, cause at least one processor to perform:
determining a target desktop from at least two display desktops; and
determining all display windows on the target desktop, the all display windows being displayed on the target desktop in a first display state and the at least two display desktops being either different display desktops of a same screen or display desktops of different screens.

19. The storage medium according to claim 18, wherein the at least one processor is further configured to perform:
determining the target desktop from the at least two display desktops in response to a desktop identification operation corresponding to the target desktop; or
determining a target screen from at least two screens; and determining at least one desktop displayed on the target screen as the target desktop.

20. The storage medium according to claim 18, wherein the at least one processor is further configured to perform:
triggering an operation of determining the target desktop in response to an operation of a preset key; or
acquiring a preset gesture to trigger an operation of determining the target desktop.
